(19) United States
(12) Patent Application Publication
(10) Pub. No.: US 2014/0054155 A1
(43) Pub. Date: Feb. 27, 2014

(54) LONG-STROKE DOME-SHAPED MOVABLE CONTACT PIECE

(71) Applicant: Junpei KAGEYAMA, Shizuoka-shi (JP)

(72) Inventor: Junpei KAGEYAMA, Shizuoka-shi (JP)

(21) Appl. No.: 13/687,070

(22) Filed: Nov. 28, 2012

(30) Foreign Application Priority Data
Aug. 22, 2012 (JP) 2012-182886
Sep. 12, 2012 (JP) 2012-200224

(51) Int. Cl. H01H 1/06

(52) U.S. Cl. CPC H01H 1/06
USPC 200/512

(57) ABSTRACT

There is provided a dome-shaped movable contact piece having a sufficient durability with a long indentation amount and with low indentation pressure, reduced in a bottom thrust feeling, and a dome-shaped movable contact piece fixedly adhering the same dome-shaped movable contact piece to a sheet. The long-stroke dome-shaped movable contact piece comprises a dome-shaped contact piece provided with a click action function, and not less than four L-shaped or triangular slits, wherein apex angle parts of the slits are directed to the central position of the dome-shaped contact piece, a central part of the dome-shaped contact piece and a peripheral part of the dome-shaped contact piece are joined with each other by joining parts each directed radially and having a uniform width. The dome-shaped contact piece is fixedly adhered to the sheet only at necessary parts thereof.

This application claims priority from Japanese Patent Application No. 2012-200224 filed Sep. 12, 2012 the entire contents of which are herein incorporated by reference.

### BACKGROUND

1. Technical Field

The present invention relates to a dome-shaped movable contact having a long stroke, i.e. a long indentation amount for use in switches of input operation sections such as a cell phone of a keyboard of an electronic device, and so forth.

2. Related Art

Many dome-shaped movable contact pieces for use in switches have circular or a disc-shaped configuration and they are molded by shaping a thin spring sheet into a dome shape so as to obtain a click feeling. In such a dome-shaped movable contact piece, in case where a height of the dome is made tall and an indentation amount is made long, e.g. not less than 0.3 mm, there are problems in that (1) an indentation pressure becomes very strong, (2) durability deteriorates because a heavy load is applied to the movable contact piece when it is deformed, (3) a bottom thrust feeling is strong and a strain is put on fingers, and so forth because an indentation amount is short at the time on or after the maximum indentation pressure is applied to the movable contact piece.

Meanwhile, if slits are formed on the movable contact piece, an indentation pressure can be lowered but stress concentration is generated in the slit sections, thereby deteriorating durability. For example, Patent Document 1 discloses a configuration wherein four fun-shaped slits are formed on one piece of spring contact sheet and spring contacts are formed a little to the centers of respective slits, thereby causing problems in that due to the existence of the spring contact, a sufficient click feeling can not be obtained, the indentation amount does not become long, and cracks tend to be generated in the part where the spring contacts are formed.

Patent Document 2 discloses a configuration wherein a circular spring material is shaped into two domes and arc-shaped long holes are formed at the middle position thereof, thereby forming a contact spring provided with two-stage click. According to such a contact spring provided with two-stage click, a long stroke is obtained by twice click feelings, but it is not suited for obtaining a simple big stroke because two-stage shaping is needed.

Patent Documents 3 and 4 disclose a configuration wherein a dome-shaped movable contact piece and a sheet are combined with each other by an adhesive agent and these are built in a switch substrate and so forth. However, these techniques have a problem in that wrinkles tend to be generated in the sheet, the adhesion between the dome-shaped movable contact piece and the sheet is unstable, and further, if there are slits in the movable contact piece, the adhesive agent leaks in the slits when used, so that operational failure tends to occur.

### PATENT DOCUMENTS

Patent Document 1: JP58-58771B2

Patent Document 2: JP2010-146737A

Patent Document 3: JP10-188728A

Patent Document 4: WO2004/055848

### SUMMARY OF THE INVENTION

It is an object of the present invention to provide a dome-shaped movable contact piece having a sufficient durability with a long indentation amount with low indentation pressure, reduced in a bottom thrust feeling, and prevent the generation of wrinkles of a sheet and leakage of an adhesive agent in advance.

To achieve the above object, a first aspect of a long-stroke dome-shaped movable contact piece of the present invention comprises a dome-shaped contact piece provided with a click action function and molded by shaping a piece of a circular or a disc-shaped elastic metal sheet into a dome shape, and not less than four L-shaped or triangular slits formed in the dome-shaped contact piece, wherein the slits are arranged with equal angular intervals relative to the center of the dome-shaped contact piece, apex angle parts of the slits are directed to the central position of the dome-shaped contact piece, a central part of the dome-shaped contact piece and a peripheral part of the dome-shaped contact piece are joined with each other by joining parts each directly radially and having a uniform width between the slits, and wherein the slits reduce a tensile force directed radially and circumferentially and render an indentation amount at the time on or after the maximum load applied to the dome-shaped contact piece to be not less than 1.0 times as large as an indentation amount at the time before the maximum load applied thereto.

According to the first aspect of the present invention, the L-shaped angle parts or triangular apex part of each slit may be arc-shaped at the central position thereof.

A second aspect of a long-stroke dome-shaped movable contact piece of the present invention comprises a dome-shaped contact piece provided with a click action function and molded by shaping a piece of a circular or a disc-shaped elastic metal sheet into a dome shape, not less than four L-shaped or triangular slits formed in the dome-shaped contact piece, and a sheet for fixedly adhering the dome-shaped contact piece thereto, wherein the slits are arranged with equal angular intervals relative to the center of the dome-shaped contact piece, apex angle parts of the slits are directed to the central position of the dome-shaped contact piece, a central part of the dome-shaped contact piece and a peripheral part of the dome-shaped contact piece are joined with each other by joining parts each directly radially and having a uniform width between the slits, wherein the slits reduce a tensile force directed radially and circumferentially and render an indentation amount at the time on or after the maximum load applied to the dome-shaped contact piece to be not less than 1.0 times as large as an indentation amount at the time before the maximum load applied thereto, and wherein the sheet is previously embossed in a convex shape of the dome-shaped contact piece, and the dome-shaped contact piece is fitted inside the embossed part of the sheet, and fixedly adhered to the sheet by an adhesive agent at the parts to make surface contact with the sheet.

According to the second aspect of the invention, the dome-shaped contact piece may be fixedly adhered to the sheet only at an outer peripheral part of the parts to make surface contact with the sheet.

According to the long-stroke dome-shaped movable contact piece of the first aspect of the present invention, it is structured such that the angle parts of the L-shaped slits and the apex angle parts of the triangular slits are directed to the central position of the dome-shaped contact piece, and they are arranged with equal angular intervals relative to the center of the dome-shaped contact piece, and not less than four slits are formed in the dome-shaped contact piece, not less than four joining parts each directly radially and having a uniform width are formed between the central part of the dome-shaped contact piece and the outer peripheral part of the same, and an indentation amount at the time on or after the application of the maximum load is rendered to be not less than 1.0 times as large as an indentation amount at the time before the application of the maximum load, thereby securing a long stroke, so that a high durability is obtained with a low indentation pressure even with a long indentation amount, and an indentation amount at the time on or after the application of the maximum indentation pressure becomes long, thereby rendering a bottom thrust feeling to be weak and a strain put on fingers to be small, and further the click sound to be reduced.

Further, according to the long-stroke dome-shaped movable contact piece of the first aspect of the present invention, since the L-shaped angle parts or triangular apex part of each slit is arc-shaped at the central position thereof, generation of cracks can be further reduced.

According to a long-stroke dome-shaped movable contact piece of the second aspect of the present invention, since the sheet is previously embossed and the dome-shaped contact piece is fitted inside the embossed part of the sheet, so that generation of deformation and wrinkles of the sheet at the adhesive part of the sheet can be reduced, and further since the dome-shaped contact piece is fixedly adhered to the sheet by the adhesive agent of the sheet at the parts to make surface contact with the sheet, namely, at the central part, the outer peripheral part and the joining parts, it is possible to previously prevent the leakage and protrusion of the adhesive agent, particularly the leakage of the adhesive agent from the slits, further, the reversing operation of the dome-shaped contact piece is not restricted by the adhesive force, thereby expecting to obtain a smooth operation of the dome-shaped contact piece.

Further, according to the long-stroke dome-shaped movable contact piece of the second aspect of the present invention, since the dome-shaped contact piece is fixedly adhered to the sheet by the adhesive agent of the sheet only at the outer peripheral part of the parts to make surface contact with the sheet, it is possible to previously prevent the leakage and protrusion of the adhesive agent, the leakage of the adhesive agent from the slits at the parts from the outer peripheral part a little to the center, further, the reversing operation of the dome-shaped contact piece is not restricted by the adhesive force at the parts from the outer peripheral part a little to the center, thereby expecting to obtain a more smooth operation of the dome-shaped contact piece.

### BRIEF DESCRIPTION OF THE DRAWINGS

FIG. 1 is a view for explaining the relation between a dome-shaped movable contact piece and a tensile force;

FIG. 2 is a view for explaining a status of generation of a tensile force between a normal movable contact piece and a movable contact piece provided with a long indentation amount, and a graph showing the relation between an indentation amount and an indentation pressure;

FIG. 3 is a view for explaining a long-stroke dome-shaped movable contact piece according to the present invention;

FIG. 4 is a view for explaining a status of generation of a tensile force of the long-stroke dome-shaped movable contact piece according to the present invention;

FIG. 5 is a graph showing the relation between an indentation amount and an indentation pressure of the prior art and those of the present invention;

FIG. 6 is a plan view showing a status of generation of cracks;

FIG. 7 is a sectional view showing a state where the long-stroke dome-shaped movable contact piece according to the present invention built in a membrane switch before operating thereof (before energization);

FIG. 8 is an enlarged sectional view showing a state where the long-stroke dome-shaped movable contact piece according to the present invention built in a membrane switch when operating thereof (when energization);

FIG. 9 is a view for explaining an adhesive surface of the movable contact piece relative to a sheet; and

FIG. 10 is another view for explaining an adhesive surface of the movable contact piece relative to a sheet.

### DETAILED DESCRIPTION OF EXEMPLARY EMBODIMENTS

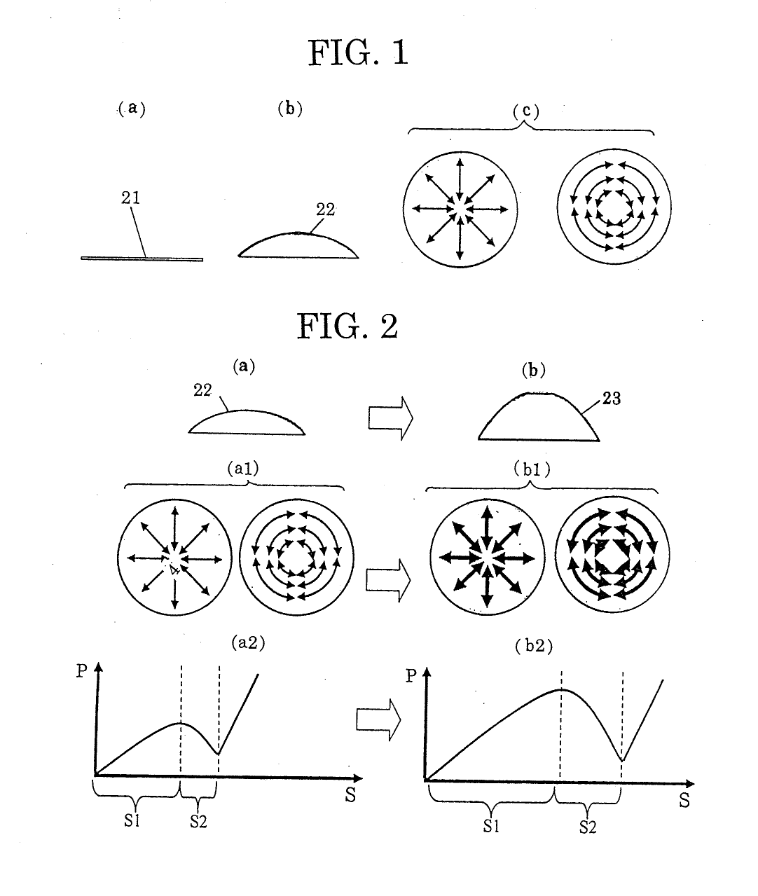

As shown in FIG. 1(a) and FIG. 1(b), in case where a piece of rolled steel plate 21 is subjected to press molding in a dome shape (bowl shape) to form a movable contact piece 22 provided with a click function, as shown in FIG. 1(c), the inside of the movable contact piece 22 is rendered in a state, after subjected to press molding, where a strong tensile force is applied in a radial direction as well as in a circumferential direction between an outer periphery and a center thereof due to press molding.

As shown in FIG. 2(a) and FIG. 2(b), the normal movable contact piece 22 is subjected to deep press molding to have a product height higher than that of the normal movable contact piece 22 so as to secure a long indentation amount, thereby forming a movable contact piece 23 provided with a long indentation amount. As shown in FIG. 2(a1) and FIG. 2(b1), tensile forces to be applied to the movable contact piece 23 provided with a long indentation amount in a radial direction and a circumferential direction become very large, resulting in showing a high indentation load as shown in the graph of indentation amount S and an indentation pressure P of FIG. 2(a2), and FIG. 2(b2), thereby deteriorating durability of the movable contact piece 23.

That is, as shown in FIG. 2(a2), according to the normal movable contact piece 22, an indentation amount S2 at the time on or after the application of the maximum load is smaller than an indentation amount S1 at the time before the application of the maximum load. However, as shown in FIG. 2(b2), according to the movable contact piece 23 provided with a long indentation amount, an indentation pressure increases corresponding to the increment of the tensile force, so that both the indentation amount S1 at the time before the maximum load applied to the movable contact piece 23 provided with a long indentation amount and indentation amount S2 at the time on or after the maximum load applied thereto become large than those of the normal movable contact piece 22. Further, the indentation amount S2 at the time on or after the application of the maximum load is still smaller than that of the indentation amount S1 at the time before the application of the maximum load.

Further, according to the movable contact piece 23 provided with a long indentation amount, since any part thereof other than the outer peripheral part thereof is rendered in a state where it is pulled or stretched from all the directions by the strong tensile force, if one part thereof begins to undergo deformation, the entire thereof is deformed at once accompanied by the deformation of the one part. As a result, the indentation amount S2 at the buckling area become short at the time on or after the application of the maximum load, thereby rendering the bottom thrust feeling strong.

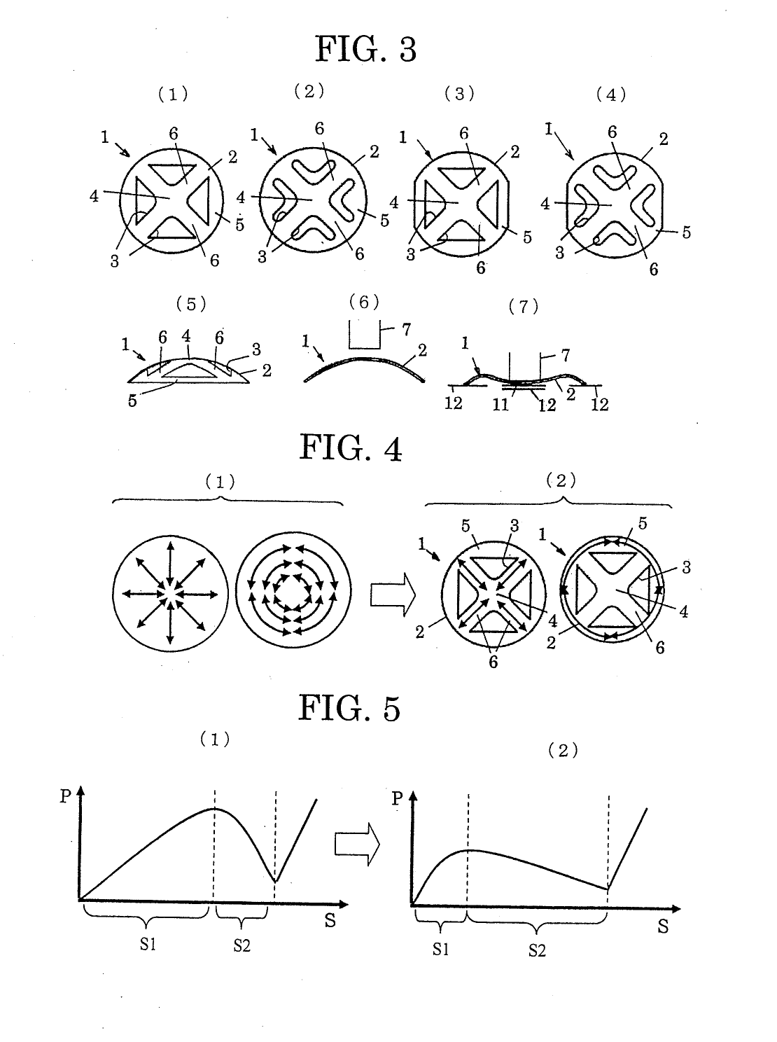

To that end, according to the present invention, as shown in FIG. 3(1) to FIG. 3(4), in order to structure a long-stroke dome-shaped movable contact piece 1, a piece of a circular or a disc-shaped elastic metal sheet is shaped into a dome shape to structure a dome-shaped contact piece 2 provided with a click function, and angle parts of the L-shaped slits or the apex angle parts of the slits 3 are directed to the central position of the dome-shaped contact piece 2, and the slits 3 are arranged with equal angular intervals relative to the center thereof, thereby forming not less than four L-shaped or triangular slits 3 in the dome-shaped contact piece (2), wherein not less than four joining parts 6 each directly radially and having a uniform width are formed between the central part 4 of the central part 2 and the outer peripheral part 5 of the same, thereby reducing a radially and circumferentially directed tensile force and rendering an indentation amount S2 at the time on or after the application of the maximum load to be not less than 1.0 times as large as an indentation amount S1 at the time before the application of the maximum load, thereby securing a long stroke, as set forth hereinafter.

The foregoing one piece of elastic metal sheet has a thickness in the order of 0.04 to 0.1 mm and is subjected to a press molding by punching out a plate such as a rolled steel plate or a rolled stainless steel plate plated with silver or nickel into a circular or a disc shape, thereby forming a dome-shaped plate having a diameter in the order of 3 to 6 mm. Not less than four slits 3 are L-shaped or triangular and intervals between the neighboring slits 3 have a uniform width, namely, form the joining pats 6 having the same width.

As shown in FIG. 3(5), the dome-shaped contact piece 2 has a dome shape as viewed from the side thereof in a state where an external force is not applied thereto (before deformation), while as shown in the shapes of sectional views in FIG. 3(6) and FIG. 3(7), when the dome-shaped contact piece 2 receives an external force (indentation pressure) at the convex side by a pusher 7, and so forth, it is flatly deformed until the time before the application of the maximum load but it is deformed under click operation at the time on or after the application of the maximum load so that the dome-shaped contact piece 2 is reversed in a warping direction at the periphery of the central part 4. When the contact piece 2 is reversed, the long-stroke movable contact piece 1 closes a pair of printing contact points 11, 12 which are opposite to each other at the central part 4, thereby rendering the printing contact points 11, 12 to be in an electrical conductive state, or closes a space between the printing contact point 11 contacting the central part 4 and the printing contact point 12 contacting the outer peripheral part 5 by the dome-shaped contact piece 2, thereby rendering the space to be in an electrical conductive state. When the external force (indentation pressure) is lost, the contact piece 2 is reversed and recovered to an original state so that the printing contact points 11, 12 are separated from each other to be rendered in a non-electrical conductive state.

With the configuration set forth above, an area on which the tensile force acts is cut off by the existence of the slits 3 so that the tensile force applied in a radial direction is reduced and the tensile force applied in a circumferential direction is limited to only a restricted area of the outer peripheral part 5. In such a manner, since the L-shaped or triangular slits are provided in the dome-shaped contact piece 2, the radially and circumferentially directed tensile forces applied to the dome-shaped contact piece 2 are reduced.

As shown in FIG. 4(1), even if the tensile tension acts on the dome-shaped contact piece 2 as made heretofore by bending work, a part where the dome-shaped contact piece 2 is deformed and operated at the time of actual switching operation is only a cross-shaped part of the dome-shaped contact piece 2, namely, the central part 4 and the joining parts 6 as shown in FIG. 4(2), so that only the radially directed tensile force applied to the joining parts 6 becomes a indentation pressure. In such a manner, the slits 3 work so as to reduce the radially and circumferentially directed tensile force applied to the dome-shaped contact piece 2.

FIGS. 5(1) and (2) show the relation between indentation amount S and an indentation pressure P according to the prior art and the present invention. Both in the prior art and the present invention, the indentation pressure P increases proportionally in the interval of indentation amount S1 at the time before the application of the maximum load (maximum indentation pressure) but it is reversely deformed owing to the click operation when exceeding the maximum load (maximum indentation pressure), and changed in the direction of its slope in the interval of indentation amount S2 at the time on or after the application of the maximum load.

As seen from the graph of FIG. 5(1) showing the relation between the indentation amount S and the indentation pressure P according to the prior art, according to the movable contact piece 23 provided with a long indentation amount which is made up of the same material and has the same indentation amount as the long-stroke dome-shaped movable contact piece 1 of the present invention, since the slope is large in the interval of the indentation amount S2 at the time on or after the application of the maximum load, the indentation amount S2 at the time on or after the application of the maximum load becomes smaller than the indentation amount S1 at the time before the application of the maximum load. On the other hand, as seen from the graph of FIG. 5(2) showing the relation between the indentation amount S and the indentation pressure P according to the present invention, since the tensile force is small according to the long-stroke dome-shaped movable contact piece 1 of the present invention, even if the long-stroke dome-shaped movable contact piece 1 is subjected to molding so as to raise a product height, i.e. a dome height in order to secure the long indentation amount, the maximum indentation pressure is not more increased to become a low indentation pressure amount, compared with the movable contact piece 23 provided with a long indentation amount according to the prior art. Owing to the low indentation pressure, a load applied to the long-stroke dome-shaped movable contact piece 1 at the time of deformation is small, and the durability is improved, yet further, in the interval of the indentation amount S2 at the time on or after the application of the maximum load, the slope is small and is gently reduced, thereby realizing the long indentation amount.

Furthermore, according to the long-stroke dome-shaped movable contact piece 1 of the present invention, since only the radially directed tensile force is applied to a cross-shaped part which is deformed when it is operated as a switch, i.e. to the central part 4 and the outer peripheral part 5, even if a part of the joints parts 6 starts to deform, the entire dome-shaped contact piece 2 is not deformed at once accompanied by the deformation of a part of the joining parts 6 but it is gently deformed.

Accordingly, the indentation amount S2 at the buckling area becomes long at the time on or after the application of the maximum load, thereby reducing the bottom thrust feeling. As a result, as shown in FIG. 5(2), the indentation amount S2 at the time on or after the application of the maximum load can be not less than 1.0 times as large as the indentation amount S1 at the time before the maximum load applied thereto, thereby realizing the long stroke. Further, the dome-shaped contact piece 2 is buckled gently compared with the prior art dome-shaped contact piece, and it strikes against the corresponding contact at the central part 4, thereby also reducing a click sound.

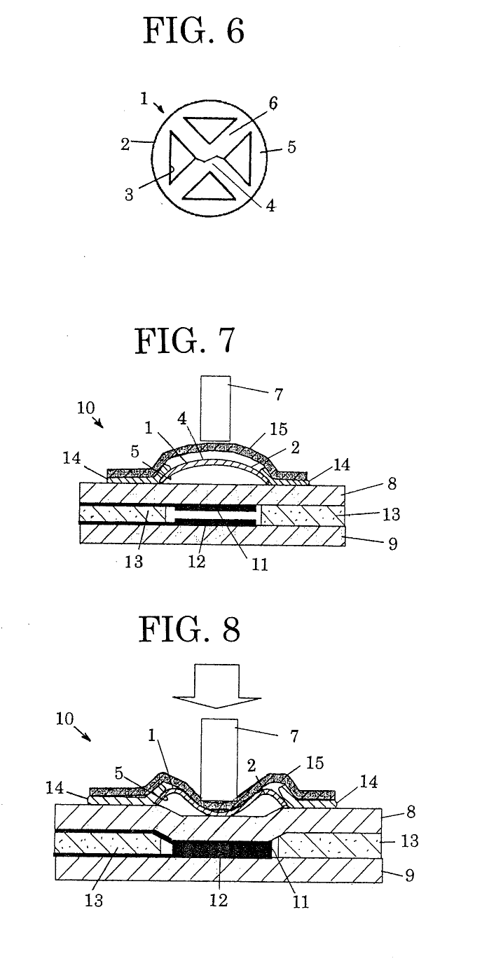

As shown in FIG. 6, if the angle parts or the apex angle part of each slit 3 is not chamfered, cracks tend to be generated at the angle parts a little to the center of each slit 3 or the apex angle part of each slit 3 during the use of the long-stroke dome-shaped movable contact piece 1. To cope with this problem, the present invention, as shown in FIG. 3(1) to FIG. (4), an L-shaped angle part at the central position of each slit 3 or the apex angle part of each slit 3 is chamfered, if need be, thereby forming in the arc-shape having a gently curve a radius of which is not less than 0.2 mm. Cracks are prevented from being generated in the angle parts of each slit 3 by chamfering the angle parts or the apex angle part of each slit 3, thereby further enhancing the durability of the product. The number of the slit 3 may be not less than 4, and these slits are arranged in the long-stroke dome-shaped movable contact piece 1 while the central angles thereof are the same.

Hereinafter the long-stroke dome-shaped movable contact piece 1 of the present invention is technically compared with the product prepared by the technique of the foregoing Patent Document 1, namely, with the contact plate, thereby clarifying the difference therebetween.

1) According to the product of the foregoing Patent Document 1, the thickness of a radially directed web in the contact point becomes thinner with distance from the center thereof. On the other hand, according to the present invention, the thickness (width) of the joining parts 6 corresponding to the radially directed web is designed to be uniform in the radial direction. When the applicant confirmed the product of the Patent Document 1 at the time of trial manufacture, the radially directed web near the center, where deformation of a material of the product and load applied to the material become the largest, is small, so that cracks are generated with ease due to stress concentration. On the other hand, according to the long-stroke dome-shaped movable contact piece 1 of the present invention, the width of joining part 6 is designed to be uniform, stress concentration is hardly generated, thereby enhancing durability.

2) According to the product of the foregoing Paten 1, spring contacts (protrusions) for contact are protruded near the center of the contact points in the direction moved away from the center, thereby rendering the product to have a shape where a stress is concentrated on the spring contacts (protrusions), so that the cracks tend to be generated. On the other hand, according to the long-stroke dome-shaped movable contact piece 1 of the present invention, spring contacts (protrusions) are not provided and it is devised to provide a large arc at the angle parts of each slit 3, so that stress concentration is hardly generated at the angle parts of each slit 3, thereby enhancing durability.

3) According to the dome-shaped movable contact pieces 22, 23 which are separated from a metal sheet at the outer peripheral part thereof as well as the long-stroke dome-shaped movable contact piece 1 of the present invention, they have a function to be crushed in flat toward the contact point surface side at the time of key entry, and the crush is enlarged in the outer peripheral direction. When the these dome-shaped movable contact pieces are also crushed in the outer peripheral direction, a force applied to the dome is further diffused, thereby obtaining an excellent click feeling. On the other hand, according to the product of the foregoing Patent 1, radially-directed webs are not separated from the spring contact plates and the outer peripheral part is a flat sheet part to be rendered in the complete restriction state, even if it is crushed, the crush is not diffused in the outer peripheral direction, thereby expecting to obtain poor click feeling.

Next, FIG. 7 and FIG. 8 show examples wherein the long-stroke dome-shaped movable contact piece 1 according to the present invention is built in a membrane switch 10. The membrane switch comprises two films 8, 9 made up of PET (hereinafter referred to PET films 8, 9) having printing contact points 11, 12 which are opposed to each other, while clamping a spacer 13 made up of PET, etc. between the PET films 8, 9, wherein the long-stroke dome-shaped movable contact piece 1 is fixedly adhered to the PET film 8 at the surface opposite to the printing contact point 11 by an adhesive agent 14. The long-stroke dome-shaped movable contact piece 1 is covered with a fixing sheet 15 made up of a thin PET film having a thickness of several 10 μm and it is partially fixedly adhered to the PET film 8 at the outer peripheral part by the adhesive agent 14 applied to the sheet 15, so that it can be key-entered by a pusher 7.

The sheet 15 is previously embossed in the convex shape of the dome-shaped contact piece 2 of the long-stroke dome-shaped movable contact piece 1, and the dome-shaped contact piece 2 contacts the embossed part of the sheet 15 at the convex surface thereof, and is fitted inside the embossed part of the sheet 15.

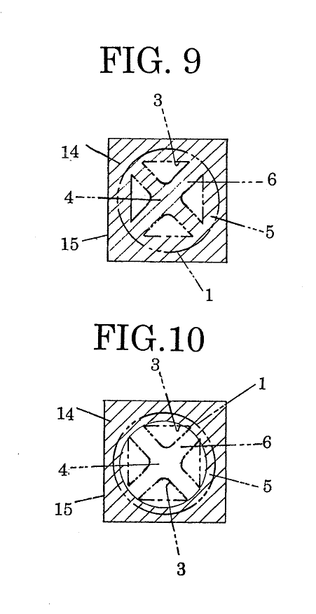

FIG. 9 and FIG. 10 are views showing an adhesive state of the dome-shaped contact piece 2 relative to the sheet 15. The dome-shaped contact piece 2 is fixedly adhered to the sheet 15 by the adhesive agent 14 of the sheet 15 at the parts to make surface contact with the sheet 15, namely, at the central part 4, the outer peripheral part 5 and the joining parts 6, as shown in hatched line in FIG. 9, or it is fixedly adhered to the sheet 15 by the adhesive agent 14 of the sheet 15 only at the outer peripheral part 5 of the parts to make surface contact with the sheet 15. The slits 3 are parts, which do not make surface contact with the sheet 15, and the adhesive agent 14 is not applied to the surface of the sheet 15 at the part corresponding to the slits 3. Accordingly, the adhesive agent 14 is not exposed at the position opposite to the slits 3.

The dome-shaped contact piece 2 is fitted inside the embossed part of the sheet 15. Accordingly, it is possible to reduce the generation of deformation and wrinkles of the sheet 15 at the adhesive part of the sheet 15. Further, the dome-shaped contact piece 2 is fixedly adhered to the sheet 15 only at the necessary parts. As a result, it is possible to previously prevent the leakage and protrusion of the adhesive agent 14, particularly the leakage of the adhesive agent 14 from the slits 3. Still further, the reversing operation of the dome-shaped contact piece 2 is not restricted by the adhesive force, thereby expecting to obtain a smooth operation of the dome-shaped contact piece 2.

When the central part 4 of the long-stroke dome-shaped movable contact piece 1 is pushed by a pusher 7, the printing contact point 11 of the PET film 8 is moved so that the interval between the printing contact points 11, 12 are electrically conducted.

When the long-stroke dome-shaped movable contact piece 1 is applied to the membrane switch 10 together with the sheet 15, it is possible to structure the switch, which is longer in the indentation amount, and lower in indentation pressure, higher in durability, and lower in bottom thrust feeling than those of the prior art.

The long-stroke dome-shaped movable contact piece according to the present invention 1 is used as a push switch for various types of equipments. The sheet 15 according to the present invention is used for fixedly adhering one long-stroke dome-shaped movable contact piece 1 thereto and also used fixedly adhering a plurality of long-stroke dome-shaped movable contact pieces thereto in accordance with the configurations of switches which the long-stroke dome-shaped movable contact pieces are built in.

What is claimed is:

1. A long-stroke dome-shaped movable contact piece of the present invention comprising:
a dome-shaped contact piece provided with a click action function and molded by shaping a piece of a circular or a disc-shaped elastic metal sheet into a dome shape; and
not less than four L-shaped or triangular slits formed in the dome-shaped contact piece;
wherein the slits are arranged with equal angular intervals relative to the center of the dome-shaped contact piece, apex angle parts of the slits are directed to the central position of the dome-shaped contact piece, a central part of the dome-shaped contact piece and a peripheral part of the dome-shaped contact piece are joined with each other by joining parts each directly radially and having a uniform width between the slits; and
wherein the slits reduce a tensile force directed radially and circumferentially and render an indentation amount at the time on or after the maximum load applied to the dome-shaped contact piece to be not less than 1.0 times as large as an indentation amount at the time before the maximum load applied thereto.

2. The long-stroke dome-shaped movable contact piece according to claim 1, wherein the L-shaped angle parts or triangular apex part of each slit is arc-shaped at the central position thereof.

3. A long-stroke dome-shaped movable contact piece (1) comprising:
a dome-shaped contact piece provided with a click action function and molded by shaping a piece of a circular or a disc-shaped elastic metal sheet into a dome shape;
not less than four L-shaped or triangular slits formed in the dome-shaped contact piece; and
a sheet for fixedly adhering the dome-shaped contact piece thereto;
wherein the slits are arranged with equal angular intervals relative to the center of the dome-shaped contact piece, apex angle parts of the slits are directed to the central position of the dome-shaped contact piece, a central part of the dome-shaped contact piece and a peripheral part of the dome-shaped contact piece are joined with each other by joining parts each directly radially and having a uniform width between the slits;
wherein the slits reduce a tensile force directed radially and circumferentially and render an indentation amount at the time on or after the maximum load applied to the dome-shaped contact piece to be not less than 1.0 times as large as an indentation amount at the time before the maximum load applied thereto; and
wherein the sheet is previously embossed in a convex shape of the dome-shaped contact piece, and the dome-shaped contact piece is fitted inside the embossed part of the sheet, and fixedly adhered to the sheet by an adhesive agent at the parts to make surface contact with the sheet.

4. The long-stroke dome-shaped movable contact piece according to claim 1, wherein the dome-shaped contact piece is fixedly adhered to the sheet only at an outer peripheral part of the parts to make surface contact with the sheet.
